(19) United States
(12) Patent Application Publication
(10) Pub. No.: US 2025/0329944 A1
(43) Pub. Date: Oct. 23, 2025

(54) Electrical Connector, Vehicle and Assembly Method

(71) Applicant: Bayerische Motoren Werke Aktiengesellschaft, Muenchen (DE)

(72) Inventors: Johannes DAHMER, Frick (CH); Bernhard HUEBNER, Eching- Viecht (DE)

(21) Appl. No.: 18/861,634

(22) PCT Filed: Apr. 6, 2023
(86) PCT No.: PCT/EP2023/059261

§ 371 Date: Oct. 30, 2024

(30) Foreign Application Priority Data
May 20, 2022 (DE) 10 2022 112 786.9

(51) Int. Cl. H01R 4/30; B60R 16/033; H01R 4/34; H01R 4/36; H01R 43/26

(52) U.S. Cl. CPC H01R 4/305; B60R 16/033; H01R 4/34; H01R 4/36; H01R 43/26; H01R 2201/26

(57) ABSTRACT

An electrical connector bas an electrically conductive sleeve with a surface region provided as a contact area to a first electrical line, an electrically insulating insulation element which laterally surrounds the sleeve, an electrically insulated screw which can be inserted into the sleeve and has at least one electrically insulated screw head, and a contact element which is displaceably and captively arranged on the screw and has a surface region provided as a contact area to a second electrical line. The contact element and the sleeve make electrical contact when the screw is tightened. A vehicle, in particular an electric vehicle, includes the electrical conductor.

### BACKGROUND AND SUMMARY

The invention relates to an electrical connector having an electrically conductive bushing with a surface region which is provided as a contact surface with a first electrical line, and a screw which can be plugged into the bushing. The invention also relates to a vehicle which has at least one electrical connector of this type. The invention relates, furthermore, to a method for mounting the connector on a component. The invention can be applied advantageously, in particular, to connectors in on-board electrical systems of vehicles, in particular on-board high-voltage subsystems, of electric vehicles.

In the case of touch-protected applications, busbars arranged on opposite sides of a component have up to now been connected to one another by way of an electrically conducting bushing which is guided through the component, by the busbars being clamped to one another by means of a screw which is guided through the busbars and the bushing. In the case of applications which are not touch-protected, a panel connector system is usually used here. It is a disadvantage here that, if the screw is released, the two connected components are still in contact, with the result that, after releasing and removing of the screw, the two busbars can still be under power, without this being apparent due to the removed screw. This is in turn a potential source of danger for a service technician or mechanic who releases the screw.

It is the object of the present invention to at least partially overcome the disadvantages of the prior art and, in particular, to provide a particularly safe possibility for interrupting contacting of electrical lines, connected by way of a bushing, in the case of a released screw.

This object is achieved according to the features of the independent claims. Preferred embodiments can be gathered, in particular, from the dependent claims.

The object is achieved by way of an electrical connector, having:
an electrically conductive bushing with a surface region which is provided as contact surface with a first electrical line,
an electrically insulating insulation element which surrounds the bushing laterally,
a screw which can be plugged into the bushing and has at least one electrically insulated screw head,
a contact element which is arranged displaceably and captively on the screw and has a surface region which is provided as contact surface with a second electrical line, wherein
the contact element and the bushing make electrical contact in the case of a tightened screw.

This connector has the advantage that, in the case of clamping (that is to say, when the screw is tightened), it provides a current path between the first electrical line and the second electrical line at least via the bushing and the contact element. If the screw shank is electrically conducting or not electrically insulated, current can additionally be conducted via the screw shank between the contact element and the bushing. If the screw is released, it takes the contact element with it, with the result that the current path between the electrical lines is safely interrupted. This can advantageously be identified by way of simple observation of the released screw. It is a further advantage that, in the case of clamping, the connector is safe to touch on this side on account of the electrically insulated screw head, and, for example, a tool which makes contact with the screw head cannot be subjected to power either.

The electrically conductive bushing has, in particular, a tubular part which is configured as a tube which is open on both sides. The bushing can therefore be a tubular bushing or can at least have a tubular part. The bushing can consist of metal, for example of copper. Via its contact surface, an electrical connection to the first electrical line can be established. The first electrical line can be fixed on the bushing, for example, by way of screwing on, soldering, welding, etc. In particular, the first electrical line can be attached to a free end surface, which is not covered by the insulation element, as the contact surface. One development which is particularly advantageous because it is reliable is that the bushing is configured in one piece with the first electrical line.

The first electrical line and/or the second electrical line can be a busbar, but are/is not restricted to this, but rather can fundamentally also be cables or a cable with a ring terminal attached on the end side.

The electrically insulating insulation element which surrounds the bushing laterally or on the shell side is, in particular, a separately produced component. Exclusive contacting of the component with the insulation element ensures that the component cannot be put under power via the connector. The insulation element can comprise, for example, plastic or ceramic. The insulation element can have at least one fastening option for fastening to a component, for example one or more screw holes. In addition or as an alternative, it can be adhesively bonded to the component.

The fact that at least the screw head of the screw is electrically insulated thereby can comprise in one development that at least the outer side of the screw head is electrically insulated. This can be achieved, for example, by way of an electrically insulating layer which encases at least the outer side. In one development, at least portions of the screw shank which has the screw thread can also be of electrically insulated configuration. In one development, the screw can be completely electrically insulated, for example by it being covered completely with an electrically insulating layer or comprising an electrically insulating material, for example ceramic.

The fact that the contact element is arranged displaceably and captively on the screw comprises, in particular, that the contact element is displaceable along the screw shank which bas the thread. To this end, the contact element can have a hole, through which the screw shank leads. Sliding of the contact element can be achieved, for example, by way of an enlarged cross section of the screw shank on a free end portion, opposite the screw head, of the screw shank. One development is that the contact element is displaceable as far as a screw head of the screw. In this case, in particular, the screw shank can have a threadless portion which starts at the screw head, along which the contact element can slide, and which merges in the direction of the tip into a portion which is provided with a screw thread and is wider than a hole of the contact element. The contact element cannot therefore slide off from the screw shank via the thread portion, but rather is taken with the screw when the latter is removed. The contact element can comprise metal, for example, copper.

The contact element or its provided contact surface is configured for electrical contacting with the second electrical line.

In the case of clamping or when the screw is tightened, the contact element and the bushing make contact mechanically and therefore also electrically, and thus close the current path between the electrical lines.

One refinement is that a contact region which projects in the direction of the bushing and/or on the side which faces away from a screw head is present on the contact element for making contact with the second electrical line. A particularly well-defined and reliable contact with the second electrical line, in particular busbar, is thus advantageously provided. The contact region has the surface region which serves as contact surface with the second electrical line, or forms this surface region. One development is that the contact region is an annular contact region, which provides a very particularly reliable contact.

One refinement is that a depression is present on the screw shank side of the screw head, into which depression portions of the contact element can dip. The advantage is thus achieved that the contact element is protected effectively against contact by the electrically insulating screw head. This refinement comprises that the contact element, in particular its projecting contact region, protrudes partially out of the depression in the case of clamping, with the result that an impairment of the contact with the second busbar is prevented. Dipping in in portions therefore comprises, in particular, that the contact region can dip in the direction along the screw or the screw shank only partially into the depression. In the case of clamping, the contact element is pressed, in particular, by way of the screw head onto the second electrical line.

One development is that the screw head has a laterally deviating, annular disk-shaped border which is covered by a layer of electrically insulating material, for example plastic, and this layer extends in the direction of the contact element over the annular disk-shaped border. The annular disk-shaped border and the overhang of the electrically insulating layer form the depression. This depression has a depth which is sufficient for partially receiving the contact element along the screw or the screw shank and is lower than the depth of the contact element.

One refinement is that the contact element has a tubular projection, through which the screw is plugged, with a cross section which at least partially intersects a contact element-side cross section of the bushing, with the result that, in the case of insertion of the screw into the bushing, a bushing-side end surface of the tubular projection can be fitted on a screw-side end surface of the bushing. In this way, the contact between the contact element and the bushing can advantageously be established particularly simply and reliably. The tubular projection is the hole of the contact element.

One refinement is that the tubular projection can be plugged into the insulation element, in particular into a tubular part thereof. This advantageously makes particularly simple production and mounting possible.

One refinement is that the bushing can be plugged into the insulation element, in particular into a tubular part thereof, namely on the opposite side to the plugging in of the screw, in particular also of the tubular projection of the contact element. This advantageously makes particularly simple production and assembly possible.

One refinement is that the insulation element has a laterally deviating projection (“flange”), and the second electrical line can be clamped in between the contact element and the flange in the case of a tightened screw. This makes secure seating of the electrical line on the connector with simple assembly possible. One development is that the flange is an annular flange, which makes particularly secure seating possible. In particular, the contact element, in particular its contact region, and the flange are oriented parallel to one another. One development is that the insulation element has a tubular part, from which the annular flange deviates laterally.

One refinement is that the bushing has a screw thread for screwing in of the screw. This advantageously makes particularly simple assembly possible. As an alternative, the screw can protrude through the bushing and can be fastened or tightened at its free end by means of a nut, possibly with a washer.

The object is also achieved by a vehicle having at least one such electrical connector. The vehicle can be of analogous configuration with respect to the connector, and has the same advantages.

It is one development that the vehicle is an electric vehicle, for example a plug-in hybrid vehicle or a fully electrically driven vehicle. The vehicle can also, however, be a vehicle which is driven by means of an internal combustion engine. The vehicle can be a passenger car, truck, motorcycle, bus, etc. The connector can be part of an on-board electrical system of the vehicle.

It is one refinement that the first electrical line can be connected to a power store, in particular a battery, in particular a traction battery, of the vehicle. On account of its particularly high isolation safety, the connector can be used particularly advantageously in power supply systems with a relatively high supply voltage, for example of 48 V, 60 V, 120 V, 400 V, 800 V or even more.

Moreover, the object is achieved by way of a method for mounting the connector on a component, in particular a vehicle, in which method:
the insulation element is fixed on the component,
the bushing is plugged into the insulation element,
the screw is plugged with the contact element from another side into the bushing, with the result that the tubular projection lies opposite the bushing in the insulation element, and then
the screw is screwed to the bushing.

The above-described properties, features and advantages of this invention and the way they are achieved will become more clearly and readily comprehensible in conjunction with the following diagrammatic description of one exemplary embodiment which will be explained in greater detail in conjunction with the drawings.

### BRIEF DESCRIPTION OF THE DRAWINGS

FIG. 1 is a side view of two electrical lines which are connected or are to be connected electrically to one another by means of an electrical connector which is shown in an exploded view;

FIG. 2 illustrates the components from FIG. 1 in a view obliquely from above with the electrical connector shown in an exploded view;

FIG. 3 is a side view of the components from FIG. 1 with the electrical connector in its assembled state;

FIG. 4 is a sectional illustration in side view of the components from FIG. 1 with the electrical connector during joining; and

FIG. 5 is a sectional illustration in side view of the components from FIG. 1 with the electrical connector in a finally assembled state.

### DETAILED DESCRIPTION OF THE DRAWINGS

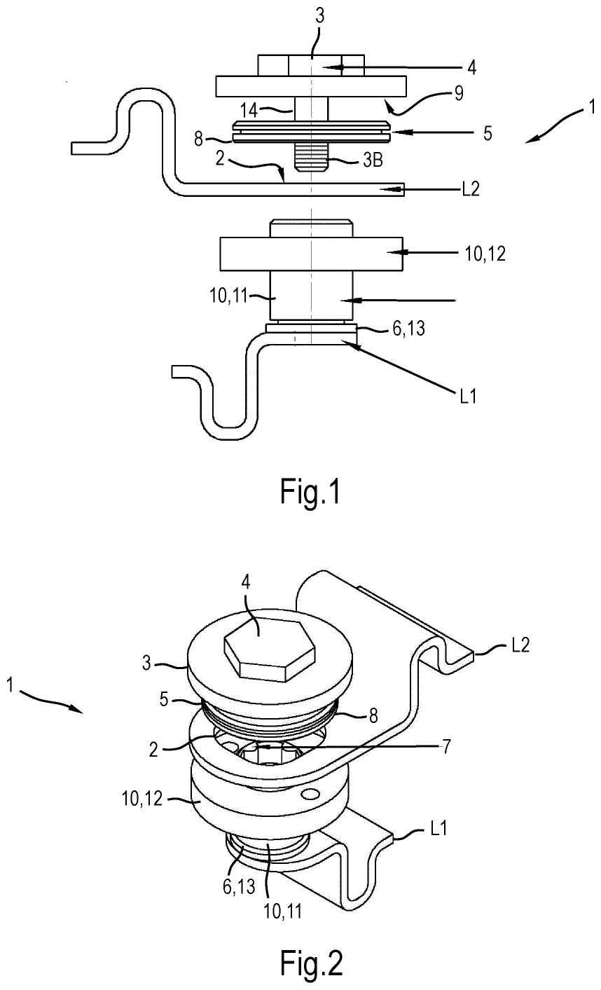

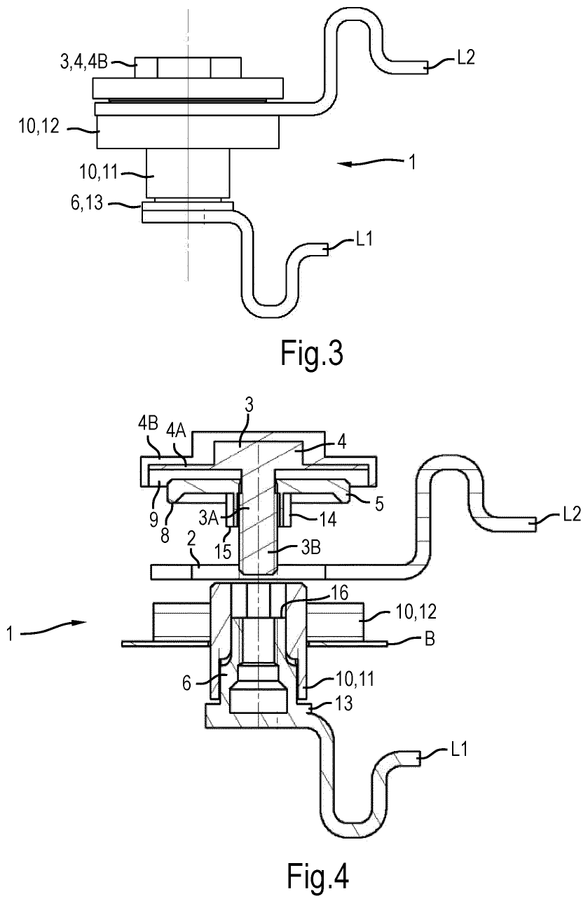

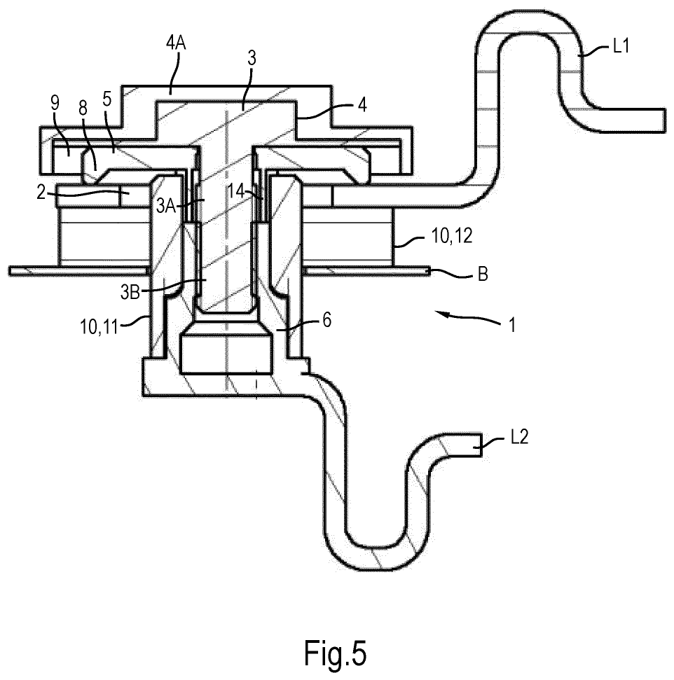

FIG. 1 is a side view of a first electrical line in the form of a first busbar L1 and a second electrical line in the form of a second busbar L2 which are connected or are to be connected electrically to one another by means of an electrical connector 1 which is shown in an exploded view. Purely by way of example, the first busbar L1 is connected to a power source of a vehicle F, in particular an electric vehicle, for example to a battery (“battery-side”). The connector 1 can connect, for example, a traction battery of a vehicle F which is configured as an electric vehicle to the associated on-board electrical system. FIG. 2 shows the connector 1 with the busbars L1 and L2 in an oblique view (denoted here as “obliquely from above”) with the electrical connector 1 likewise in an exploded view. FIG. 3 shows the connector 1 in its assembled state with the busbars L1 and L2 in a side view. FIG. 4 shows a sectional illustration in side view of the components from FIG. 1 with the electrical connector 1 in a joined state. FIG. 5 shows a sectional illustration in side view of the components from FIG. 1 with the electrical connector 1 in its finally assembled state.

The busbar L2 has a hole 2 (see FIG. 2 and FIG. 4), through which an electrically insulated screw 3 which has an electrically insulated screw head 4 can be plugged in from above. Here, by way of example, the screw head 4 has a metallic head region with a disk-like widened portion 4A which is covered on the upper side by an electrically insulating layer 4B. As an alternative, the screw 3 can consist completely of electrically insulating material, for example can be configured as a ceramic screw. A disk-shaped contact element 5 which is electrically conductive is arranged displaceably and captively on a screw shank of the screw 3. To this end, the screw shank has a threadless portion 3A (see FIG. 4 and FIG. 5) which starts at the screw head 4, and along which the contact element 5 can slide as far as a portion 3B which is provided with a screw thread. Here, the contact element 5 is displaceable up to contact with the screw head 4, in particular also with its disk-like widened portion 4A. The contact element 5 can comprise metal, for example copper. The screw 3 can be plugged into an electrically conductive bushing 6, for example made from copper, and can be screwed to the latter. To this end, the bushing 6 can have a portion (without illustration) which can be screwed to the threaded portion 3B of the screw 3. As shown in FIG. 2, the bushing 6 can have tapered portions 7 on the inner side to ensure contact protection.

On its edge region, furthermore, the contact element 5 has an annular contact region 8 which projects in the direction of the bushing 6. As can be seen from FIG. 4 and FIG. 5, the screw head 4 has, on its screw-side side, a depression 9, into which portions of the contact element 5 can dip, with the result that at least the projection 8 protrudes at least partially out of the depression 8. The depression 9 is formed by means of the disk-like widened portion 4A and a ring, projecting beyond the edge of the widened portion 4A in the direction of the bushing 6, of the electrically insulating layer 4B.

A lateral shell surface of the bushing 6 is surrounded at least partially by an electrical insulation element 10 which has a tubular part 11, into which the bushing 6 is plugged, and an annular flange 12 which deviates laterally therefrom. The flange 12 serves as a contact surface of the busbar L2 which is plugged onto the tubular part 11. Therefore, in the case of clamping with tightening of the screw 3, the busbar L2 can be clamped in between the contact element 5 and the flange 12.

At its end which faces away from the contact element, the bushing 6 merges in one piece into the first busbar L1 or is an end region of the first busbar L1. The bushing 6 optionally has a widened portion 13 here.

Furthermore, the contact element 5 has a tubular projection 14, through which the threadless portion 3A of the screw 3 is plugged displaceably. The tubular projection 14 can be plugged into the insulation element 10 through the opening which lies opposite the bushing 6. The tubular projection 14 bas a cross section which at least partially overlaps a contact element-side cross section of the bushing 6, with the result that, as shown in FIG. 4, a bushing-side end surface 15 of the tubular projection 14 can be placed on a screw-side end surface 16 of the bushing 6 when the screw 3 is inserted into the bushing 6.

FIG. 5 shows the connector 1 in a finally assembled state, in which the screw 3 is tightened. The end faces 15 and 16 are therefore in contact with one another. In the case of a tightened screw 3, the contact element 5 is pulled further in the direction of the bushing 6, with the result that contact between these end surfaces occurs. The annular contact region 8 is then also moved onto the busbar L2. The connector 1 then provides at least one electrical current path from the busbar L2 through or to the bushing 6, through the contact element 4 and via its annularly projecting projection 9 to the second busbar L2 (or vice versa). Here, in the case of clamping, the connector 1 is in practice contact-safe on account of the electrical insulation of the screw 3 and the insulation element 10. If the screw shank is also electrically conductive, a conduction of current between the bushing 6 and the contact element 4 can additionally take place via it. If the screw 3 is released and separated with the contact element 5 from the bushing 6, it is ensured that a flow of current between the busbar L1 and the busbar L2 is interrupted.

Mounting of the connector 1 on a component B which is sheet-shaped here by way of example can be formed as follows, for example:

The insulation element 10 is plugged through a hole in the component B and is fixed to the latter, for example via blind bores (without illustration) which are present in the flange 12 on the lower side.

Before this, at the same time as this or following this, the screw 3 is plugged with the contact element 5 from the other side (here, on the upper side) into the bushing 6, with the result that the tubular projection 14 lies opposite the bushing 6 in the insulation element 10.

The screw 3 is then screwed to the bushing 6, as a result of which (a) the busbar L2 is clamped in between the contact element 5 and the flange 12, and (b) the projection 14 is pulled onto the bushing 6 until it makes contact.

It goes without saying that the present invention is not restricted to the exemplary embodiment which is shown.

In general, “a”, “an”, etc. can be understood in the singular or in the plural, in particular in the sense of “at least one” or “one or more”, etc., unless this is explicitly ruled out, for example by the term “precisely one”, etc.

A numerical indication can also comprise precisely the indicated number and a customary tolerance range, unless this is explicitly ruled out.

### LIST OF DESIGNATIONS

1 Connector
2 Hole
3 Screw
3A Threadless portion
3B Threaded portion
4 Screw head
4A Layer of electrically insulating material
5 Contact element
6 Bushing
7 Tapered portion
8 Annular contact region
9 Depression
10 Insulation element
11 Annular part of the insulation element
12 Flange of the insulation element
13 Widened portion
14 Tubular projection
15 Bushing-side end surface of the tubular projection
16 Screw-side end surface of the bushing
B Component
F Vehicle
L1 First busbar
L2 Second busbar

1-11. (canceled)

12. An electrical connector, comprising:
an electrically conductive bushing with a surface region which is provided as a contact surface with a first electrical line;
an electrically insulating insulation element which surrounds the bushing laterally;
a screw which is pluggable into the bushing and has at least one electrically insulated screw head;
a contact element which is arranged displaceably and captively on the screw and has a surface region which is provided as a contact surface with a second electrical line,
wherein the contact element and the bushing make electrical contact in a case of a tightened screw.

13. The electrical connector according to claim 12, wherein
a contact region, which is annular and projects in a direction of the bushing, is provided on the contact element for making contact with the second electrical line.

14. The electrical connector according to claim 13, wherein, on a screw shank side of the screw, the screw head has a depression into which portions of the contact element can dip.

15. The electrical connector according to claim 12, wherein
the contact element has a tubular projection, through which the screw is plugged, with a cross section which at least partially intersects a contact element-side cross section of the bushing, with a result that, in case of an insertion of the screw into the bushing, a bushing-side end surface of the tubular projection is fitted on a screw-side end surface of the bushing.

16. The electrical connector according to claim 15, wherein the tubular projection is pluggable into the insulation element.

17. The electrical connector according to claim 12, wherein the bushing is pluggable into the insulation element.

18. The electrical connector according to claim 12, wherein
the insulation element bas a laterally deviating flange, and
the second electrical line is clamped in between the contact element and the flange in the case of the tightened screw.

19. The electrical connector according to claim 12, wherein the bushing has a screw thread for screwing-in of the screw.

20. A vehicle comprising an electrical connector according to claim 12.

21. The vehicle of claim 20, wherein the vehicle is an electric vehicle.

22. The vehicle according to claim 20, wherein
the first electrical line is connected to a power store of the vehicle.

23. The vehicle according to claim 21, wherein the first electrical line is connected to a traction battery of the vehicle.

24. A method for mounting an electrical connector on a component, the method comprising:
fixing an electrically insulating element on the component, the electrically insulating insulation element surrounding laterally an electrically conductive bushing having a surface region provided as a contact surface with a first electrical line;
plugging the bushing into the insulation element;
plugging a screw, having an electrically insulated screw head and having a contact element with a tubular projection arranged displaceably and captively on the screw, the contact element having a surface region provided as a contact surface with a second electrical line, with a result that the tubular projection lies opposite the bushing in the insulation element, and then
screwing the screw to the bushing.
